(19) United States
(12) Patent Application Publication
(10) Pub. No.: US 2017/0246753 A1
(43) Pub. Date: Aug. 31, 2017

(54) CONDUIT GRIPPER AND HAND GUARD, SYSTEM, AND METHODS OF USE

(71) Applicant: Gregory Shane Palmer, Demorest, GA (US)

(72) Inventor: Gregory Shane Palmer, Demorest, GA (US)

(21) Appl. No.: 15/056,624

(22) Filed: Feb. 29, 2016

(51) Int. Cl. B26B 29/06; B26D 7/01; B26D 3/16; B23D 59/00

(52) U.S. Cl. CPC B26B 29/06; B23D 59/00; B26D 7/01; B26D 3/169; B26D 2007/013

(57) ABSTRACT

A conduit gripper and hand guard apparatus, system, and methods of use thereof that includes a two piece cylindrical gripper having a first grip member and a second grip member hinged therebetween to grip the conduit, a hand shield integral with said first grip member to shield the user's hand during cutting of the conduit, said hand shield formed with a slot therein, the slot positioned between a perimeter edge and an interior of said hand shield, and a saw stop protruding from said hand shield, and, thus, functions to be compact, enables gripping of the conduit for positioning and measurement, enables safe standup cutting of the conduit.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

Technical Field

The disclosure generally relates to hand tools, and more specifically to hand maneuvered tool guides.

Description of Related Art

Electricians, plumbers, telecommunications and other workers as well as do it yourselfers who are cutting conduit or other thin wall pipe may perform such conduit cuts barehanded to cut a length or segment of conduit. One disadvantage of this approach is that any slip while cutting can result in worker injury. Occupational safety dictates the use of chain vise for hand safety and such chain vices may be equipped with a stand such as a tripod. One disadvantage of this approach is that these chain vises are heavy and cumbersome, weighing approximately forty-five pounds. As such a worker does not transport the chain vise up ladders or with them on scissor lifts but rather transports the conduit after positioning and measurement back down to the chain vice for cutting of the conduit.

Another approach is to utilize a plate vise to cut conduit or other thin wall pipe. One disadvantage of this approach is that these plate vises are designed for use on the ground or other surface requiring bending over to use the vice or positioning the conduit into a designated hole in the plate vise. As such a worker does not transport the plate vise up ladders or with them on scissor lifts but rather transports the conduit after positioning and measurement back down to the plate vice for cutting of the conduit.

Therefore, it is readily apparent that there is a recognizable unmet need for a conduit gripper and hand guard that is compact, enables gripping of the conduit for positioning and measurement, enables safe standup cutting of the conduit, provides a hand guard or shield from the cutting tool, may be utilized at the point of installation of the conduit, is light weight and transportable in or attached to a workers tool belt, and enables gripping and handling of multiple sizes of conduit.

### SUMMARY

Briefly described, in a preferred embodiment, the present apparatus and method overcomes the above-mentioned disadvantages and meets the recognized need for such a device by providing a conduit gripper and hand guard apparatus, system, and methods of use thereof that includes a two piece cylindrical gripper having a first grip member and a second grip member hinged therebetween to grip the conduit, a hand shield integral with said first grip member to shield the user's hand during cutting of the conduit, said hand shield formed with a slot therein, the slot positioned between a perimeter edge and an interior of said hand shield, and a saw stop protruding from said hand shield, and, thus, functions to be compact, enables gripping of the conduit for positioning and measurement, enables safe standup cutting of the conduit, provides a hand shield or additional shield from the cutting tool, may be utilized at the point of installation of the conduit, is light weight and transportable in or attached to a workers tool belt, and enables gripping and handling of multiple sizes of conduit.

More specifically, an example embodiment of the present apparatus of a conduit gripper and hand shield, includes a two piece cylindrical shaped gripper having a first grip member and a second grip member hinged therebetween along a common edge to grip the conduit. A bias device such as a spiral spring positioned along a hinge pin and inserted therebetween a common edge therebetween the first grip member and the second grip member. A hand shield positioned proximate a first end of the first grip member to shield the user's hand from a cutting blade. The hand shield formed with a v-shaped slot, the v-shaped slot formed between a perimeter edge and an interior of said hand shield. A left and right aperture formed in the hand shield and positioned on opposite sides of the v-shaped slot. A saw stop attached to either of the left and right aperture and protrudes therefrom said hand shield to catch or stop the saw body and not the saw blade.

In an exemplary embodiment of the conduit gripper and hand guard including a two piece gripper having a first grip member and a second grip member, the first grip member and the second grip member having a hinge therebetween, a hand shield integral with a first end of the first grip member, the hand shield formed with a slot therein, the slot positioned between a perimeter edge and an interior of the hand shield, and a rigid linear saw stop protruding from the hand shield opposite the first grip member.

In a further exemplary embodiment the conduit gripper and hand guard, includes A system for safely cutting a conduit, the system including a section of conduit and a reciprocating blade, a two piece gripper having a first grip member and a second grip member, the first grip member and the second grip member having a hinge therebetween, a hand shield integral with a first end of the first grip member, the hand shield formed with a slot therein, the slot positioned between a perimeter edge and an interior of the hand shield, whereby the conduit is releasably held therein the first grip member and the second grip member and the slot, and a rigid linear saw stop protruding from the hand shield opposite the first grip member, whereby the rigid linear saw stop halts a downward motion of the hand saw after cutting the conduit.

In still a further exemplary embodiment of the method of safely cutting a conduit with a hand saw, the method including the steps of providing a conduit gripper and hand guard, the conduit gripper and hand guard comprises a two piece gripper having a first grip member and a second grip member, the first grip member and the second grip member having a hinge therebetween, a hand shield integral with a first end of the first grip member, the hand shield formed with a slot therein, the slot positioned between a perimeter edge and an interior of the hand shield, and a rigid linear saw stop protruding from the hand shield opposite the first grip member, gripping the conduit therein the slot and between the first grip member and the second grip member, and cutting the conduit held therein.

Another feature of the conduit gripper and hand guard is its ability to be interchangeable between a right and a left hand tool by positioning the saw stop in either of the left or right aperture formed in the hand shield.

Still another feature of the conduit gripper and hand guard is its ability to grip and cut a variety of conduit sizes gripped therein the v-shaped slot and held between the two piece cylindrical conduit gripper having a first grip member and a second grip member and therebetween.

Yet another feature of the conduit gripper and hand guard is its ability to save time in man-hours to position, measure, cut, and assemble conduit.

Yet another feature of the conduit gripper and hand guard is its ability to provide a safer hand tool device that shields a cutter's hand while cutting conduit and protects and stops downward motion of the cutting blade after passing through the conduit.

Another feature of the conduit gripper and hand guard is its ability to provide a two piece cylindrical conduit gripper having a first grip member and a second grip member hinged therebetween along a common edge to grip a variety of sizes of conduit.

Another feature of the conduit gripper and hand guard is its ability to provide a V-shaped or tapered, or stepped slot to enable gripping of a variety of sizes of conduit.

Another feature of the conduit gripper and hand guard is its ability to provide a two piece cylindrical gripper having a first grip member and a second grip member hinged therebetween along a common edge to grip, pickup, position, measure, cut and assemble a variety of sizes of conduit.

Another feature of the conduit gripper and hand guard is its ability to provide a two piece cylindrical gripper having a first grip member and a second grip member hinged therebetween along a common edge wherein a bias member, such as a spiral spring provides a normally open gripper to position, grip, pickup, measure, cut and assemble a variety of sizes of conduit.

Another feature of the conduit gripper and hand guard is its ability to enable a user to perform a safe standup cut of the conduit whether on the ground, ladder, scissor lift or the like.

Another feature of the conduit gripper and hand guard is its ability to be compact and hand carried or attached to a work belt and easily transported to and from the work site.

Another feature of the conduit gripper and hand guard is its ability to provide a grip end positioned proximate a second end of the first grip member and the second grip member.

Another feature of the conduit gripper and hand guard is its ability to provide a set of alternating holed tabs and un-notched areas, and notches positioned along a common edge between the first grip member and the second grip member to form the hinge therebetween via a hinge pin.

Another feature of the conduit gripper and hand guard is its ability to provide a hinge pin to removeably affix the first grip member and the second grip member to form the hinge along a common edge between the first grip member and the second grip member.

Another feature of the conduit gripper and hand guard is its ability to be utilize a variety of saws such as porta band, sawzall, hacksaw, circular, reciprocating, continuous loop, and other hand saws or cutting devices (hand saw).

Another feature of the conduit gripper and hand guard is its ability to provide an additional hand guard that extends from the hand shield to protect the hand when cutting conduit.

Another feature of the conduit gripper and hand guard is its ability to avoid providing a saw slot or groove for a hand saw blade to travel, and thus eliminating a precise saw blade alignment task.

These and other features of the conduit gripper and hand guard and its method of use thereof will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present conduit gripper and hand guard, system and method of use thereof will be better understood by reading the Detailed Description with reference to the accompanying drawings, which are not necessarily drawn to scale, and in which like reference numerals denote similar structure and refer to like elements throughout, and in which:

FIG. 1 is a perspective view of an exemplary embodiment of the conduit gripper and hand guard;

FIG. 2 is a rear view of the embodiment of FIG. 1;

FIG. 3 is a bottom view of the embodiment of FIG. 1;

FIG. 4 is a front exploded perspective view of the embodiment of FIG. 1;

FIG. 5 is a rear exploded perspective view of the embodiment of FIG. 1 showing the hinge assembly;

FIG. 6 is a top exploded view of the embodiment of FIG. 1 showing the hinge notches, tabs, and hinge pin, and saw stop assembly;

FIG. 7A is a rear view of the embodiment of FIG. 1 showing conduit gripper in closed position;

FIG. 7B is a rear perspective view of the embodiment of FIG. 1 showing conduit gripper in closed position;

FIG. 7C is a front view of the embodiment of FIG. 1 showing conduit gripper in closed position;

FIG. 8A is a rear view of an alternate embodiment of FIG. 1 shown with an additional hand guard extending from the hand shield;

FIG. 8B is a rear perspective view of FIG. 8A shown with an additional hand guard extending from the hand shield;

FIG. 8C is a front view of FIG. 8A;

FIG. 9 is a perspective view of FIG. 1 shown in use with a hand gripping the conduit gripper to grip and cut conduit with a saw blade; and

FIG. 10 is a flow chart depicting an exemplary embodiment of the method of gripping, selecting, inserting, closing, positioning, measuring, cutting, and assembling a conduit while gripping with one hand.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

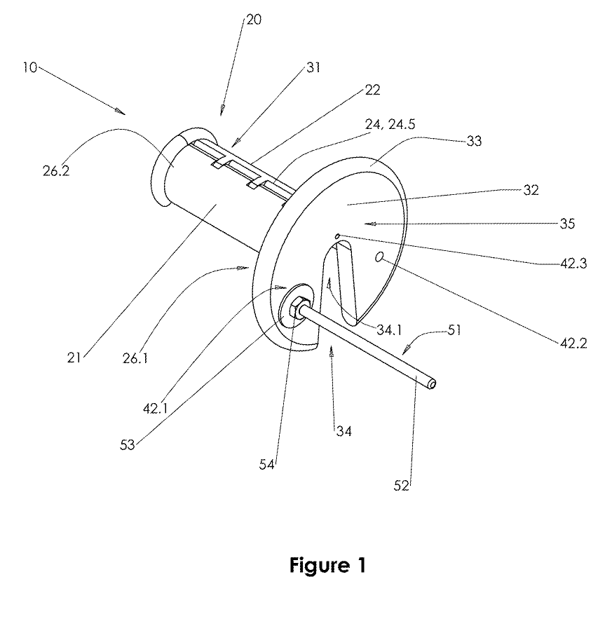

In describing the exemplary embodiments of the present disclosure, as illustrated in FIGS. 1-10, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

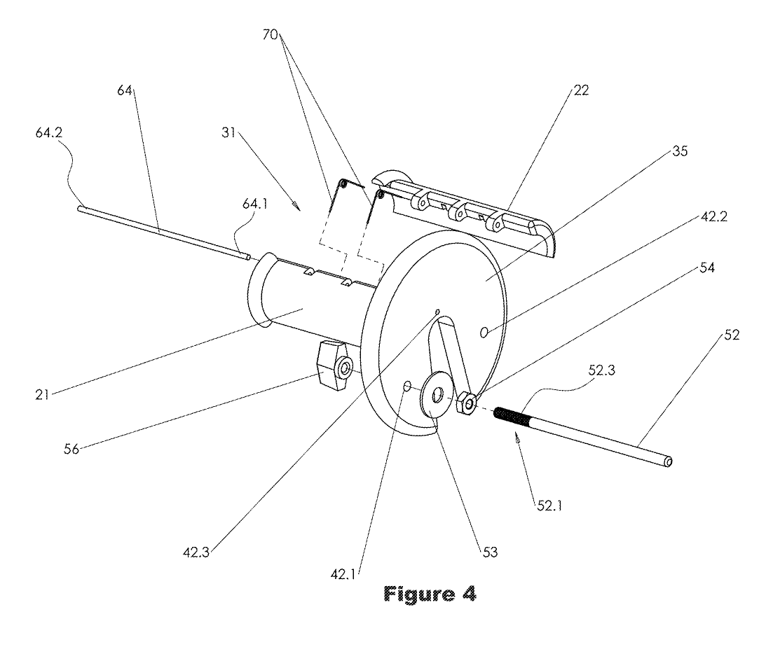

Referring now to FIGS. 1-9 and specifically to FIGS. 1 and 4 by way of example, and not limitation, therein is illustrated example embodiments of conduit gripper and hand guard 10. As shown therein a perspective view, conduit gripper and hand guard 10 generally comprises a multi-piece gripper, such as conduit gripper 20 having first grip member 21 and second grip member 22. First grip member 21 and second grip member 22 may be configured as a partial or partially cylindrical shaped (cross-section) to enable gripping of a variety of sizes of conduit. Moreover, first grip member 21 and second grip member 22 may be pivoted relative each other along a longitudinally edge in a manner of a clam shell defining an interior cavity therebetween into which a conduit may be placed. Conduit herein is preferably inclusive of any linear member capable of being gripped between first grip member 21 and second grip member of conduit gripper 20, such as thin walled conduit or pipe, thick walled conduit or pipe, solid bars or solid structures of a variety of materials and the like. More specifically conduit gripper 20 may be utilized to grip conduit sized from preferably half inch (½″) to three quarters inch (¾″) or one inch (1″) but other sizes or diameters inclusive of U.S. or metric are contemplated herein (conduit). Preferably a longitudinal pivotal or rotational assembly, such as hinge 31 may be positioned proximate common longitudinal edge, such as edge 24 (24.1 and 24.5) between first grip member 21 and second grip member 22 of conduit gripper 20. Either of first grip member 21 or second grip member 22, but preferably first grip member 21 may be configured having a cross guard, quillons, hand guard or protector, such as hand shield 32 preferably positioned proximate first end 26.1 of first grip member 21 and preferably at approximately a right angle to first grip member 21, wherein hand shield 32 may be disc shaped or any other shape capable of covering, protecting or shielding a hand grasping first grip member and second grip member 22 of conduit gripper 20. Moreover, hand shield 32 may include a cutout therein, such as slot 34. Slot 34 may be formed therein hand shield 32 from an outer edge of hand shield 32, such as perimeter 33 to an inner portion of hand shield 32, such as interior 35, and more specifically may extend to an inner portion proximate where first end 26.1 of first grip member 21 may be connected thereto hand shield 32. Preferably, slot 34 may be notched, tapered or stepped from perimeter 33 to interior 35 to form such as a V-shaped (or alternatively a “V” having a bull nose or rounded end 34.1 rather than a point proximate interior 35) slot 34 to enable a variety of sizes of conduit to be positioned within slot 34 and may abut rounded end 34.1 and such variety of sizes of conduit may be gripped by first grip member 21 and second grip member 22 of conduit gripper 20. Hand shield 32 may include one or more holes, such as aperture 42 and more specifically first aperture 42.1 and second aperture 42.2 may be utilized as left and right hand apertures utilized to releasably affix a rigid and/or linear member, such as saw stop 51 thereto hand shield 32 and may include a stopper, such as bar 52. Preferably, first aperture 42.1 and second aperture 42.2 may be positioned on opposing or opposite sides of slot 34 again to enable left and right hand apertures for saw stop 51, and thus left and right hand use of conduit gripper and hand guard 10. Moreover, saw stop 51 may be attached to either of first aperture 42.1 and second aperture 42.2 and preferably protrudes therefrom hand shield 32 to halt or stop a downward motion, catch or stop the saw body (hand saw) not the saw blade after the saw blade has cut through the conduit. Preferably saw stop 51 may be affixed therein first aperture 42.1 and second aperture 42.2 and releasably affixed to hand shield 32 using flat washer 53 and jam nut 54. It is contemplated herein that other attachment means may be incorporated herein such as glue or adhesive, formed or molded, threaded, latched, friction fit and the like to releasably affix saw stop 51 therein first aperture 42.1 or second aperture 42.2.

It is contemplated that configurations or shapes other than cylindrical for first grip member 21 and second grip member 22 and disc shaped for shield 32 are contemplated herein, including, without limitation a squared, triangular, polygonal, oval, or other shape. Moreover, first grip member 21, second grip member 22, and shield 32 may preferably be formed of a suitable material, such as plastic, rubber, wood, composite material, sheet metal, aluminum or the like, such as via a stamping or molding procedure as commonly known in the art, and are capable of providing structure to first grip member 21 and second grip member 22 and hand shield 32. Preferably, the suitable material includes other desirable characteristics, such as high durability, water resistance, light weight, heat resistance, corrosion resistance, electrical insulation, ease of workability, or other desirable characteristic, as understood by those ordinarily skilled in the art. However, it will be recognized that variations of this arrangement may still provide the same or similar functionality.

It is recognized herein that conduit gripper and hand guard 10 may include a clip or clasp, such as work belt clasp to releasably affix conduit gripper and hand guard 10 thereto a user or user's work belt.

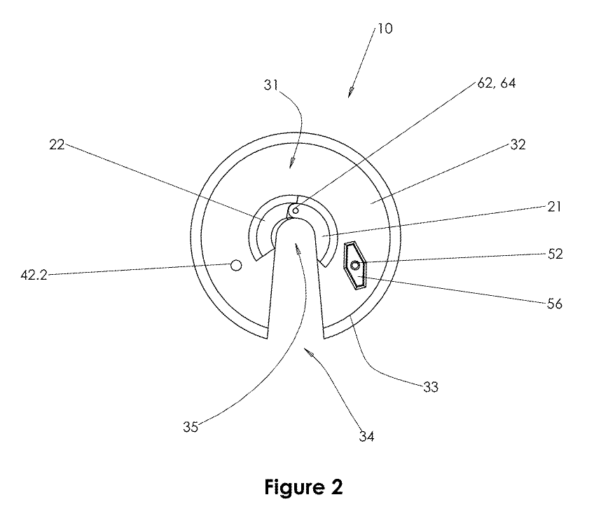

Referring now to FIGS. 2 and 4 by way of example, and not limitation, therein is illustrated an example embodiment of conduit gripper and hand guard 10. As shown therein a rear view, conduit gripper and hand guard 10 generally comprises slot 34 formed therein hand shield 32 from an outer edge of hand shield 32, such as perimeter 33 to an inner portion of hand shield 32, such as interior 35, and more specifically may extend to an inner portion proximate where first grip member 21 and second grip member may pivot, such as pivot point 62 or hinge pin 64. It is contemplated herein that pivot point 62 or hinge pin 64 may be positioned anywhere proximate slot 34 and more specifically positioned therein interior 35 proximate an inner most or deepest position of slot 34 therein hand shield 32. Preferably, slot 34 may be tapered or stepped from perimeter 33 to interior 35 to form a V-shaped slot 34 to enable a variety of sizes of conduit to be positioned within slot 34 and such variety of sizes of conduit may be gripped by first grip member 21 and second grip member 22 of conduit gripper 20.

Moreover, bar 52 of saw stop 51 may be affixed therein first aperture 42.1 or second aperture 42.2 and releasably affixed to hand shield 32 using turn knob 56. It is contemplated herein that other attachment means may be incorporated herein such as glue or adhesive, formed or molded, threaded, latched, friction fit and the like to releasably affix saw stop 51 therein first aperture 42.1 or second aperture 42.2.

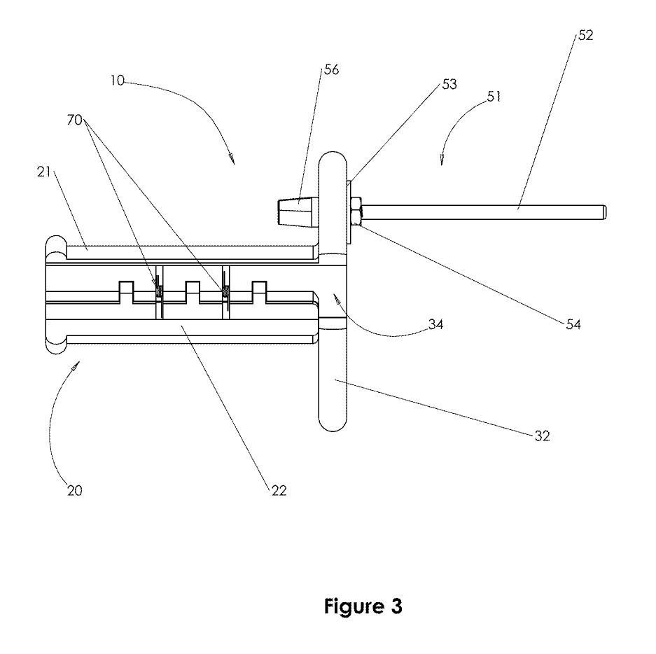

Referring now to FIGS. 3 and 4 by way of example, and not limitation, therein is illustrated an example embodiment of conduit gripper and hand guard 10. As shown therein a bottom view, conduit gripper and hand guard 10 generally comprises first grip member 21 and second grip member 22 of conduit gripper 20, hand shield 32 having slot formed therein, and saw stop 51. Conduit gripper and hand guard 10 may include a bias element or device such as spiral spring 70 positioned proximate hinge pin 64 and more specifically may be wound around hinge pin 64 (hinge pin 64 may be inserted through or received therein third aperture 42.3 of hand shield 32) along a hinge pin and inserted therein a common edge therebetween the first grip member 21 and the second grip member 22. Moreover, spiral spring 70 preferably maintains first grip member 21 and second grip member 22 in a normally-open position as shown in FIG. 2 ready to grip conduit inserted therein.

Referring now to FIG. 4 by way of example, and not limitation, therein is illustrated example embodiments of conduit gripper and hand guard 10, as shown therein a front exploded parts view. Preferably conduit gripper and hand guard 10 includes

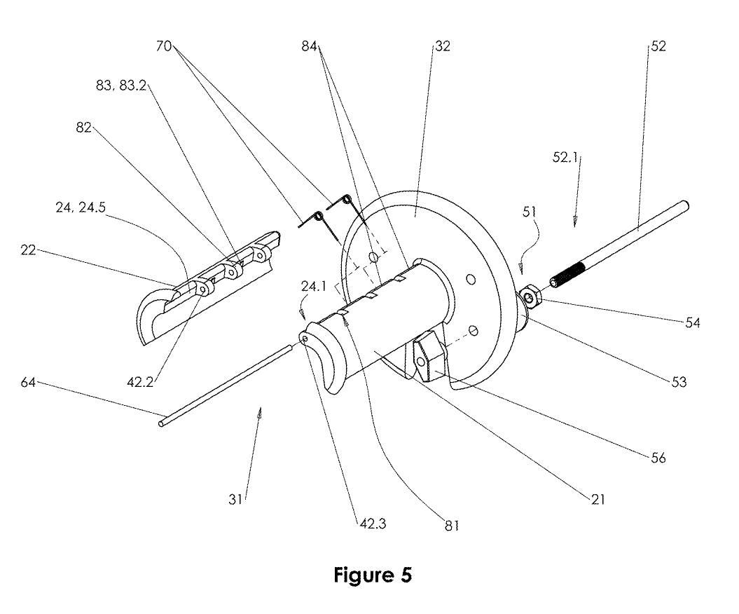

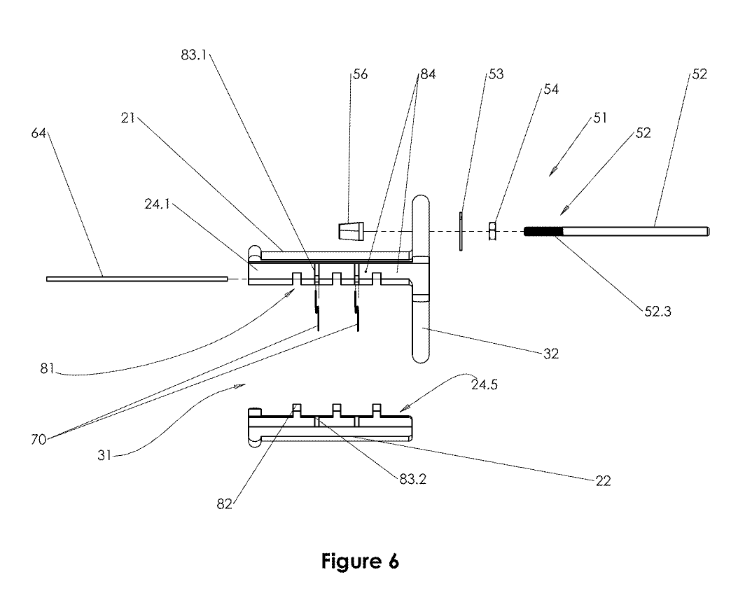

Referring now to FIGS. 5 and 6 by way of example, and not limitation, therein is illustrated example embodiments of conduit gripper and hand guard 10. As shown therein an rear and bottom exploded parts view conduit gripper and hand guard 10 generally comprises bar 52 of saw stop 51 having two ends and one such end, first bar end 52.1 may include a threaded end 52.3 to engage turn knob 56 or alternatively threaded first aperture 42.1 or second aperture 42.2 of hand shield 32. Moreover, conduit gripper and hand guard 10 preferably includes a pivotal or rotational assembly, such as hinge 31 and hinge 31 may be positioned proximate common edge 24 (24.1 and 24.5) between first grip member 21 and second grip member 22 of conduit gripper 20. More specifically, hinge 31 may include one or more protrusions, such as tab 82 and tab 82 may include aperture 42.4 (holed tabs 82) positioned longitudinally with second grip member 22 and proximate common edge 24.2. Furthermore, hinge 31 may include one or more directly opposite indentations to accommodate, mirror or match tab 82, such as notch 81 and holed un-notched remaining sections 84 may include aperture 42.3 positioned longitudinally with first grip member 21 and proximate common edge 24.1. Still furthermore, hinge 31 may include one or more directly opposite indentations, such as spring notch 83 positioned longitudinally with first grip member as spring notch 83.1 and another directly opposite spring notch 83 positioned longitudinally with second grip member 22 as spring notch 83.2 proximate common edge 24.5. Together one of one or more tab 82 and one of one or more notch 81 may be fitted together and with tab 82 includes aperture 42.4 mated together with one of one or more notch 81 and with hinge pin 64 inserted therein mated one or more tab 82 and one of one or more notch 81, and thus, provide hinge 31 to enable open and closure of first grip member 21 and/or second grip member 22 of conduit gripper 20. It is contemplated herein that hinge 31 may include other configurations to rotationally affix first grip member 21 and/or second grip member 22.

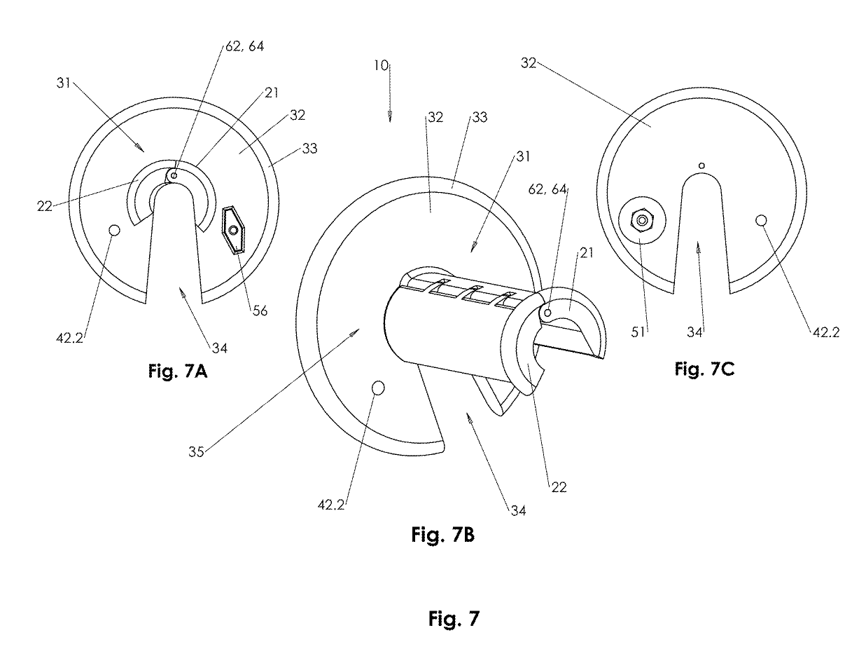

Referring now to FIGS. 7A, 7B, and 7C by way of example, and not limitation, therein is illustrated example embodiments of conduit gripper and hand guard 10. As shown therein a rear, perspective and front view conduit gripper and hand guard 10 generally comprises slot 34 formed therein hand shield 32 from an outer edge of hand shield 32, such as perimeter 33 to an inner portion of hand shield 32, such as interior 35, and more specifically may extend to an inner portion proximate where first grip member 21 and/or second grip member may pivot, such as pivot point 62 or hinge pin 64. In use, hinge 31 may be configured to enable open and closure in direction 92 of first grip member 21 and/or second grip member 22 of conduit gripper 20 to grip conduit therein. More specifically first grip member 21 may be configured or formed integral thereto hand shield 32 and second grip member 22 may rotate about first grip member 21 via hinge 31 to enable open and closure in a curved or arcing motion or as a clam shell, such as rotational or arcing direction 92 of second grip member 22 relative to first grip member 21 and/or slot 34 to grip conduit therein. It is recognized herein that direction 92 may include open, close and positions therebetween to grip or release conduit therein first grip member 21 and/or second grip member 22.

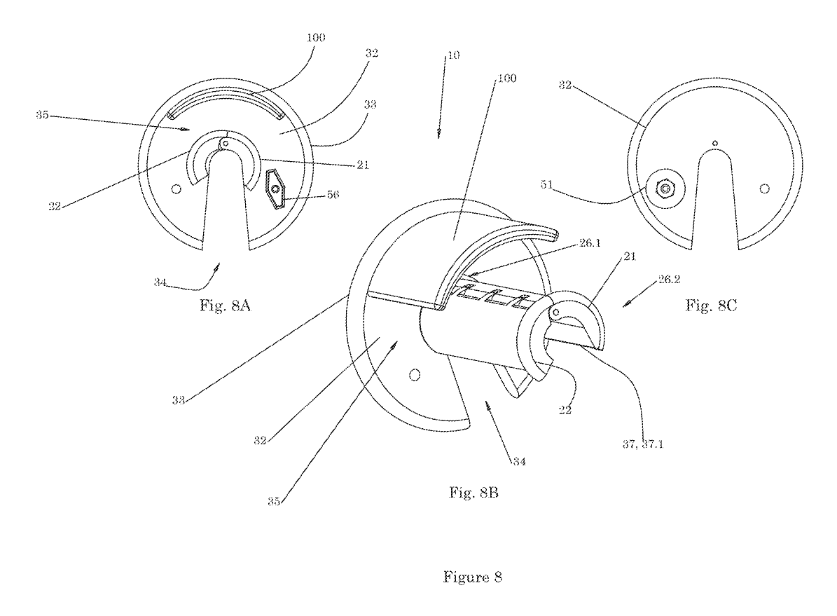

Referring now to FIGS. 8A, 8B, and 8C by way of example, and not limitation, therein is illustrated example embodiments of conduit gripper and hand guard 10. As shown therein a rear, perspective and front view conduit gripper and hand guard 10 generally comprises conduit gripper 20 having first grip member 21 and second grip member 22 and hand shield 32. Moreover, conduit gripper and hand guard 10 may be configured having a hand guard extension or protector extension, such as hand shield extension 100 preferably extending therefrom hand shield 32 proximate perimeter 33 and preferably in parallel relation to first grip member 21, wherein hand shield extension 100 may be configured as curved or arcing or any other shape capable of covering, protecting or shielding a hand clasping first grip member 21 and second grip member 22 of conduit gripper 20. It is contemplated herein that shield extension 100 may extend from hand shield 32 to proximate second end 26.2 of first grip member 21 and more specifically may be configured as curved or arcing or any other shape capable of additional coverage, protection or shielding of a hand clasping first grip member 21 and second grip member 22 of conduit gripper 20.

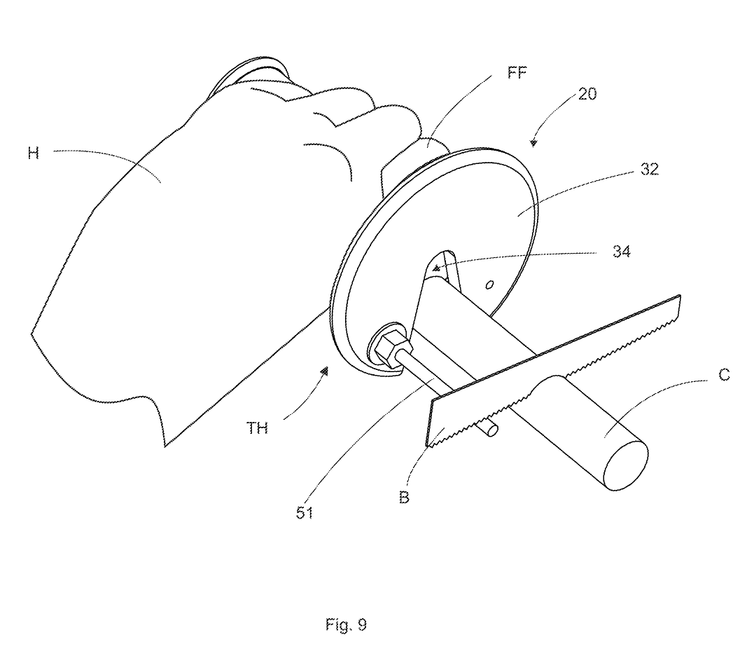

Referring now to FIG. 9 by way of example, and not limitation, therein is illustrated example embodiments of conduit gripper and hand guard 10. As shown therein in a perspective view of conduit gripper and hand guard 10 generally comprises conduit gripper 20 having first grip member 21 and second grip member 22 and hand shield 32. Moreover, spiral spring 70 preferably maintains first grip member 21 and second grip member 22 in a normally-open position about hinge 31 as shown in FIG. 2 ready to grip conduit C inserted therein. In use, a user may grip first grip member 21 and second grip member 22 with their right or left hand H and such hand's forefinger FF and thumb TH may be positioned proximate hand shield 32 or proximate first end 26.1 of first grip member 21 as shown in FIG. 1. As shown in FIG. 7 hinge 31 may be configured to enable open and closure in arcing direction 92 of first grip member 21 and/or second grip member 22 of conduit gripper 20 to enable grip and release of conduit C inserted therein conduit gripper and hand guard 10. Moreover, hand shield extension 100 as shown in FIG. 8 may be included with conduit gripper and hand guard 10 to provide additional coverage, protection or shielding of a hand H clasping first grip member 21 and second grip member 22 of conduit gripper 20 and when cutting conduit C. Moreover, conduit gripper and hand guard 10 may be utilized to grip or handle conduit C, to select or identify a conduit C to grip, to insert conduit C into slot 34, to close first grip member and second grip member 22 of conduit gripper and hand guard 10 around the conduit C and hold conduit C therein slot 34 while gripping with one hand H, to position or measure conduit C held therein first grip member 21 and second grip member 22, to safely cut conduit C via a saw blade, such as hand saw blade B, and thereafter to assemble conduit C by a user.

It is contemplated herein that interior surface 37 of first grip member 21 and second grip member 2 may be lined with a friction or tacky surface, such as plastic or rubber segments 37.1 for grasping the surfaces of conduit C therein.

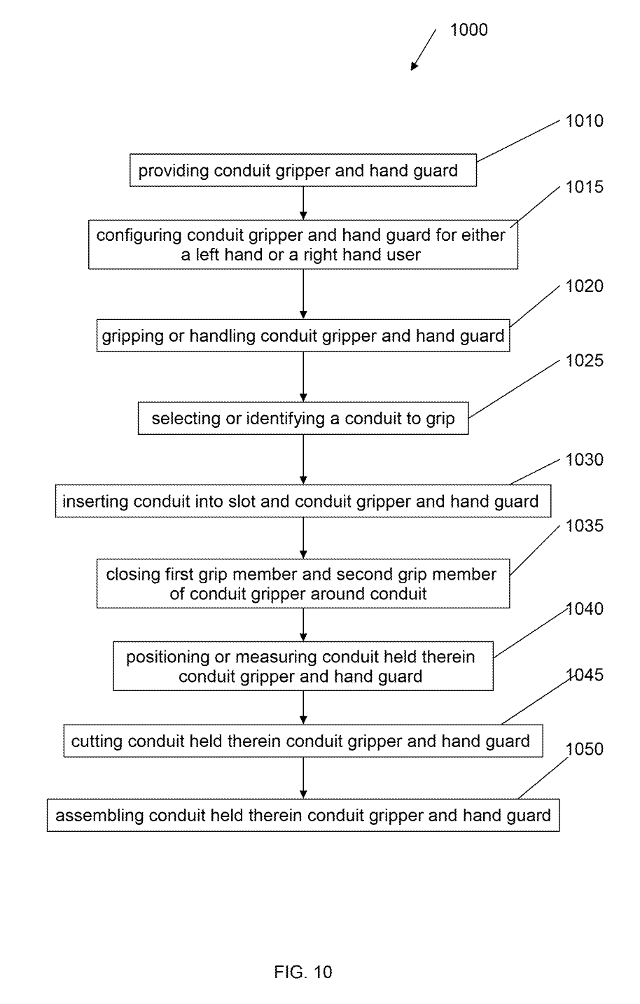

Referring now to FIG. 10, there is illustrated a flow diagram 1000 of a method of utilizing conduit gripper and hand guard 10. In block or step 1010, providing conduit gripper and hand guard 10 for use in cutting conduit, as described above in FIGS. 1-9. In block or step 1015, configuring conduit gripper and hand guard 10 for either a left hand or a right hand user by removing turn knob 56 and positioning saw stop 51 in either aperture 42 and more specifically first aperture 42.1 (left hand grip) or second aperture 42.2 (right hand grip) may be utilized as left and right hand apertures utilized to releasably affix saw stop 51 to hand shield 32. In block or step 1020, gripping or handling conduit gripper and hand guard 10 by a user's hand. In block or step 1025, selecting or identifying a conduit to grip with conduit gripper and hand guard 10. In block or step 1030, inserting or gripping conduit into slot 34 and conduit gripper 20 and more specifically therebetween having first grip member 21 and second grip member 22 of conduit gripper and hand guard 10. In block or step 1035, closing first grip member 21 and second grip member 22 of conduit gripper and hand guard 10 around conduit and holding conduit therein slot 34 while gripping with one hand. In block or step 1040, positioning or measuring conduit held therein first grip member 21 and second grip member 22 of conduit gripper and hand guard 10 around conduit and holding conduit therein slot 34 while gripping with one hand. In block or step 1045, cutting conduit held therein first grip member 21 and second grip member 22 of conduit gripper and hand guard 10 around conduit and holding conduit therein slot 34 while gripping with one hand. In block or step 1045, assembling conduit held therein first grip member 21 and second grip member 22 of conduit gripper and hand guard 10 around conduit and holding conduit therein slot 34 while gripping with one hand.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A conduit gripper and hand guard, said conduit gripper and hand guard comprising:
a two piece gripper having a first grip member and a second grip member, said first grip member and said second grip member having a hinge therebetween;
a hand shield configured integral with a first end of said first grip member, said hand shield formed with a slot therein, said slot positioned between a perimeter edge and an interior of said hand shield; and
a rigid linear saw stop protruding from said hand shield opposite said first grip member.

2. The conduit gripper and hand guard of claim 1 wherein said hand shield is disc shaped.

3. The conduit gripper and hand guard of claim 1 wherein said first grip member and said second grip member are a partial cylindrical shaped.

4. The conduit gripper and hand guard claim 1 wherein said slot is tapered.

5. The conduit gripper and hand guard of claim 1 wherein said slot is V shaped.

6. The conduit gripper and hand guard of claim 1, further comprises a first aperture and a second aperture positioned on opposing sides of said slot, whereby said first aperture and said second aperture are configured for a left hand and a right hand positioning of said rigid linear saw stop.

7. The conduit gripper and hand guard of claim 1, wherein said first grip member and said second grip member are configured to be in a normally-open position.

8. The conduit gripper and hand guard of claim 1 wherein said hinge further comprises a bias element.

9. The conduit gripper and hand guard of claim 8 wherein said bias element is a spiral spring.

10. The conduit gripper and hand guard of claim 1 further comprising a grip end positioned proximate a second end of said first grip member and said second grip member.

11. The conduit gripper and hand guard of claim 1 wherein said hinge further comprises a set of alternating holed tabs, a set of holed un-notched areas, and at least one notch positioned along a common edge between said first grip member and said second grip member.

12. The conduit gripper and hand guard of claim 11, wherein said first grip member and said second grip member further comprises a hinge pin therebetween.

13. The conduit gripper and hand guard of claim 12 wherein said hand shield further comprises a third aperture, said third aperture configured to receive a first end of said hinge pin.

14. The conduit gripper and hand guard of claim 11 wherein said hand shield further comprises a hand shield extension configured to extend therefrom said hand shield proximate said perimeter and configured in a parallel relation to said first grip member.

15. The conduit gripper and hand guard claim 1 wherein said slot further comprises a rounded end proximate said interior of said hand shield.

16. The conduit gripper and hand guard claim 1 wherein said rigid linear saw stop is configured to releasably affix thereto said hand shield.

17. The conduit gripper and hand guard claim 16 wherein said rigid linear saw stop further comprises a threaded end.

18. The conduit gripper and hand guard of claim 1, further comprises a work belt clasp.

19. The conduit gripper and hand guard of claim 1, further comprises a friction surface configured on an interior surface of between said first grip member and said second grip member.

20. A system for safely cutting a conduit, said system comprising:
a section of conduit and a hand saw;
a two piece gripper having a first grip member and a second grip member, said first grip member and said second grip member having a hinge therebetween;
a hand shield integral with a first end of said first grip member, said hand shield formed with a slot therein, said slot positioned between a perimeter edge and an interior of said hand shield, whereby said conduit is releasably held therein said first grip member and said second grip member and said slot; and
a rigid linear saw stop protruding from said hand shield opposite said first grip member, whereby said rigid linear saw stop halts a downward motion of said hand saw after cutting said conduit.

21. A method of safely cutting a conduit with a hand saw, said method comprising the steps of:
providing a conduit gripper and hand guard, said conduit gripper and hand guard comprises a two piece gripper having a first grip member and a second grip member, said first grip member and said second grip member having a hinge therebetween,
a hand shield integral with a first end of said first grip member, said hand shield formed with a slot therein, said slot positioned between a perimeter edge and an interior of said hand shield, and a rigid linear saw stop protruding from said hand shield opposite said first grip member;
gripping the conduit therein said slot and between said first grip member and said second grip member; and
cutting the conduit held therein.

22. The method of claim 21, further comprising the step of stopping a downward motion of the hand saw after cutting the conduit.
